(19) United States
(12) Patent Application Publication
(10) Pub. No.: US 2012/0271673 A1
(43) Pub. Date: Oct. 25, 2012

(54) Systems and Methods for Facility Management and Maintenance Tracking

(76) Inventor: Dennis Riley, Woodstock, IL (US)

(21) Appl. No.: 13/420,090

(22) Filed: Mar. 14, 2012

Related U.S. Application Data
(60) Provisional application No. 61/452,470, filed on Mar. 14, 2011.

(51) Int. Cl. G06Q 10/00

(52) U.S. Cl. 705/7.12

(57) ABSTRACT

Systems and methods are utilized by facility managers for facility management and maintenance tracking. Specifically, systems and methods provide facility managers with the ability to manage one or more facilities in an organization or a company. More specifically, systems and methods of the present invention provide facility managers the ability to manage facilities and track information relating to the facilities, manage service required at the facilities, and manage bids from vendors for capital projects to the facilities.

The present invention claims priority to U.S. Provisional Patent App. No. 61/452,470, filed Mar. 14, 2011, incorporated herein by reference in its entirety.

### TECHNICAL FIELD

The present invention relates to systems and methods for facility management and maintenance tracking. Specifically, systems and methods of the present invention provide facility managers with the ability to manage one or more facilities in an organization or a company. More specifically, systems and methods of the present invention provide facility managers the ability to easily and efficiently manage facilities and track information relating to the facilities, manage service required at the facilities, and manage bids from vendors for capital projects to the facilities.

### BACKGROUND

Of course, traditional companies and other organizations require one or more facilities to conduct business. These facilities may include buildings and land that house personnel and equipment to perform the activities required of the companies. For example, many businesses are goods manufacturers and/or service providers, requiring one or more facilities for manufacturing as well as managing the companies.

Companies and other organizations often have huge capital expenditure costs for the building and maintaining of facilities. While the cost of building facilities may be large, the cost of maintaining the facilities to maximize their use may also be quite large. For example, buildings have infrastructure that require periodic maintenance to ensure that the buildings are useful for their intended purposes. Roofs, walls, windows and other structural elements may fail, especially over time, with the normal wear and tear of use. HVAC systems, plumbing systems, and other environmental systems also require upkeep for continued use. In addition, parking lots and grounds further require maintenance to ensure that the facilities are useful for their intended purposes.

Oftentimes, it is difficult to manage the needs of facilities to ensure that the facilities continue their usefulness. Even a single facility, including the structure of one or more buildings, as well as environmental and other systems, and parking and grounds, may be difficult to manage and maintain. Many companies have many facilities, oftentimes spread out over huge geographic regions, making it difficult to centrally manage the facilities.

When maintenance or other work is required on any particular facility, vendors may typically be contacted to provide services. For example, if a particular building has a roof leak, a roofer may be called to fix the problem. Of course, any maintenance issues of facilities may be handled in a similar manner. Once the vendor is called, he or she may require an on-site inspection, and typically provides an estimate of work to be performed for fixing the problem. Once approved, the vendor may perform the work, and may invoice the company or organization for the work performed. However, the inspection, the estimate of work, the performance of work, and the final report on the repair and invoice may take a relatively long period of time to accomplish, such as days, especially if it is difficult for the pertinent parties to communicated with each other, which may be typical if a facility manager is separated from the facility and/or the vendor by a large distance.

Typically, once a problem is discovered at a facility, a manager must decide which vendor to call. It may be difficult to determine a vendor that may have the requisite skill and experience to handle a particular problem. Moreover, although specific managers may have preferred vendors, a new, replacement or substitute manager may not know or may not have accessibility to a manager's preferred list of vendors. In many cases, new managers must start from scratch to determine good and experienced vendors. Thus, a need exists for systems and methods for providing information to facilities managers regarding qualified vendors to maintain consistent work quality for problems that may occur to facilities.

Once the vendor is called, it may be difficult to track when or whether a vendor arrives on-site to review the problem. A problem with a facility may happen at any time, such as at night outside of business hours, on weekends and/or during holidays, when the facilities may be vacant. Thus, there may not be many people for the vendor to interact with regarding the reporting their review of the problem. A further need, therefore, exists for systems and methods for improving communication between vendors and facility managers for tracking on-site arrival of vendors to ensure that the problems are in the process of being fixed.

Once the vendor reviews the problem, he or she typically generates an estimate for the work to be performed to fix the problem. In many cases, estimates must be approved by facility managers and the work must be approved prior to the vendor performing the work. It may be difficult for a responsible facility manager to obtain estimates and other required paperwork for review and approval thereof. Thus, a need exists for systems and methods for quickly and easily obtaining estimates and/or other paperwork from vendors, required for approval thereof prior to vendors performing the work.

Once approval is granted on work to be performed, it may be difficult to inform the vendor that the work has been approved and the vendor may begin performing the work. Moreover, it may take a significant amount of time to move through these steps of reviewing the work to be performed and providing an estimate by a vendor, and reviewing and approving the work to be performed by a facility manager. Once approval is granted, enough time may have elapsed that the vendor may be unavailable to perform the work, or may require that the work be scheduled at a later date. If the problem is catastrophic or has serious effects on the usability of facility, the companies or other organizations may suffer. A further need, therefore, exists for improvements in informing a vendor of approval of work to be performed so that a vendor may quickly begin the work to fix a problem. Moreover, a need exists for quickly and efficiently instructing vendors of approval of work to be performed.

After a vendor has completed a project, it may be difficult for the vendor to communicate to the responsible facility manager the scope of work actually performed. Moreover, it is often difficult for a facility manager to understand what work has been performed, and whether the work was performed satisfactorily so that the problem does not recur or cause other problems. Thus, a need exists for systems and methods for providing information from vendors to one or more facilities managers regarding the work actually performed, showing the facility managers that the work has been performed correctly and completely.

A vendor may then provide his or her invoice for the work performed. It may be difficult to track the invoice for payment thereof, especially when the company or organization is very large. Moreover, it may be difficult for the company or organization to provide quick and efficient approval of payment of the invoice. Often, approval must be obtained from individuals who may not have or have access to sufficient information relating to the project and the work performed by the vendor. In such cases, an individual may have to provide approval on work that may be shoddy or incomplete, or may have to waste time tracking down information relating to the project so that a fully informed decision may be rendered. Thus, a need exists for systems and methods for tracking invoices from vendors. Moreover, a need exists for systems and methods for obtaining information relating to projects performed by vendors so that informed decisions on the payment of vendor invoices may be made.

After a vendor performs work, it may be difficult for a company or organization to determine whether the vendor should be called for additional projects if necessary. Thus, a need exists for systems and methods for obtaining vendor ratings and storing the ratings for use in the future.

Moreover, if one or more facility managers must manage a plurality of facilities, such as buildings and/or grounds spread out over large geographic areas, it may be difficult to perform the necessary tasks of obtaining quality vendors for performing work thereon. Thus, a need exists for systems and methods for central managing of a plurality of facilities, including obtaining local vendors for work to be performed at any particular facilities, even while separated over large geographic distances.

While routine maintenance must be performed periodically on facilities in some cases, vendors may also be contacted for capital improvements, such as building additions, parking lot expansion, and/or other similar capital projects. Typically, companies or other organizations request bids from a plurality of vendors to provide the work to be performed. It is oftentimes difficult to communicate the scope of any particular project to the plurality of bidders in a quick and efficient manner. Moreover, it is oftentimes difficult for a company or other organization to obtain and review the plurality of bids received from vendors to determine the best bid. Thus, a need exists for systems and methods for easily and efficiently requesting and reviewing bids from vendors for capital projects for facilities.

### SUMMARY OF THE INVENTION

The present invention relates to systems and methods for facility management and maintenance tracking. Specifically, systems and methods of the present invention provide facility managers with the ability to manage one or more facilities in an organization or a company. More specifically, systems and methods of the present invention provide facility managers the ability to manage facilities and track information relating to the facilities, manage service required at the facilities, and manage bids from vendors for capital projects to the facilities.

To this end, in an embodiment of the present invention, a system for centrally managing a plurality of facilities is provided. The system comprises a database comprising information relating to the plurality of facilities, a module for communicating with a vendor for providing service on at least one of the facilities, and a module for the vendor to document service on a facility, and storing information relating to the communication with the vendor and/or information relating to the service performed on the facility by the vendor.

In an embodiment of the present invention, a method for centrally managing a facility is provided. The method comprises: providing a facility requiring maintenance; providing a database comprising a report relating to maintenance requirements of the facility; retrieving the report on a first electronic computing device from the database via a control application module interconnected with the database; creating an electronic service ticket relating to the maintenance requirements of the facility; sending a request for service to a vendor from the first computing device; and providing access to the electronic service ticket to the vendor, wherein the vendor adds information to the service ticket to create an updated electronic service ticket using a second electronic computing device.

In an embodiment, the report relates to the maintenance requirements of the facility and is generated by the step of providing access to the facility to an inspector, wherein the inspector creates the report on a third electronic computing device relating to the maintenance requirements of the facility and wherein the inspector saves the report to the database.

In an embodiment, the method further comprises providing an inspection application module on the electronic computing device of the inspector, wherein the inspection application module is interconnected to the control application module.

In an embodiment, the inspector inspects a portion of the facility, and further the report relates to maintenance requirements of the portion of the facility.

In an embodiment, the inspector adds photographs to the report.

In an embodiment, the inspector tags the photographs with information.

In an embodiment, the third electronic computing device is a portable electronic computing device.

In an embodiment, the method further comprises the step of: providing a graphic interface on the first computing device, wherein the control application provides a map on the graphic interface on the first computing device, wherein the map shows the facility.

In an embodiment, the database comprises information relating to a plurality of vendors, and the vendor selected for sending the request for service is one of the plurality of vendors.

In an embodiment, the database comprises information relating to a plurality of facilities requiring maintenance, wherein the facility selected for service is one of the plurality of facilities.

In an embodiment, the method further comprises the step of requesting an inspection on the facility, wherein the request for the inspection is generated by the control application module and sent to the inspector, wherein the report relating to the maintenance requirements of the facility are generated after the request for inspection is received by the inspector.

In an embodiment, the vendor adds photographs to the electronic service ticket using the second electronic computing device to create the updated electronic service ticket.

In an embodiment, the vendor tags the photographs with information using the second electronic computing device to create the updated electronic service ticket.

In an embodiment, the vendor adds information to the electronic service ticket relating to a repair performed on the facility using the second electronic computing device to create the updated electronic service ticket.

In an embodiment, the second electronic computing device is a portable electronic computing device.

In an embodiment, the vendor adds information to the electronic service ticket relating to additional repair needs required by the facility to create the updated electronic service ticket.

In an embodiment, the method further comprises the step of: sending a map showing the facility from the control application module to the second electronic computing device for use by the vendor.

In an embodiment, the information added to the electronic service ticket relates to cost information associated with repairing the facility.

In an embodiment, the vendor saves the updated electronic service ticket to the database using the second electronic computing device.

In an embodiment, the electronic service ticket comprises a request for bids from a plurality of vendors. The method further comprises the steps of: submitting the electronic service ticket to the plurality of vendors; and retrieving a plurality of updated electronic service tickets from the plurality of vendors, wherein each updated electronic service ticket comprises bid information.

It is, therefore, an object of the present invention to provide systems and methods for the management of one or more facilities by a facility manager, either in one location or spread over large geographical areas.

It is a further object of the present invention to provide systems and methods for providing information to facility managers regarding qualified vendors to maintain consistent work quality for problems that may occur to facilities.

It is an additional object of the present invention to provide systems and methods for improving communication between vendors and facility managers for tracking on-site arrival of vendors to ensure that the problems are in the process of being fixed.

Moreover, it is an object of the present invention to provide systems and methods for quickly and easily obtaining estimates and/or other paperwork from vendors, required for approval thereof prior to vendors performing the work.

Further, it is an object of the present invention to provide systems and methods for informing a vendor whether work to be performed has been approved so that the vendor may quickly begin the work to fix a problem.

Still further, it is an object of the present invention to provide systems and methods for for quickly and efficiently instructing vendors regarding approval of work to be performed.

It is an additional object of the present invention to provide systems and methods for providing information from vendors to one or more facility managers regarding the work actually performed, showing the facility managers that the work was performed correctly and completely.

Also, it is an object of the present invention to provide systems and methods for tracking invoices from vendors.

Moreover, it is an advantage of the present invention to provide systems and methods for obtaining information relating to projects performed by vendors so that informed decisions on the payment of vendor invoices may be made.

It is a further object of the present invention to provide systems and methods for obtaining vendor ratings and storing the ratings for use in the future.

It is a still further object of the present invention to provide systems and methods for central managing of a plurality of facilities, including obtaining local vendors for work to be performed at any particular facilities, even while separated over large geographic distances.

Moreover, it is an object of the present invention to provide systems and methods for easily and efficiently requesting and reviewing bids from vendors for capital projects for facilities.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present embodiments, by way of example only, not by way of limitations. In the figures, like reference numerals refer to the same or similar elements.

FIG. 1 illustrates a system having a plurality of modules, such as one or more Control Application Modules, one or more Inspection Application Modules, and one or more Dispatch Application Modules, in an embodiment of the present invention.

### DETAILED DESCRIPTION OF THE PRESENTLY PREFERRED EMBODIMENTS

The present invention relates to systems and methods for facility management and maintenance tracking. Specifically, systems and methods of the present invention provide facility managers with the ability to manage one or more facilities in an organization or a company. More specifically, systems and methods of the present invention provide facility managers to manage facilities and track information relating to the facilities, manage service required to the facilities, and manage bids from vendors for capital projects to the facilities.

It should be noted that a facility manager may be any individual or organization tasked with managing one or more facilities. For example, the facility manager may be an individual within a company or organization tasked with managing one or more facilities within that company or organization. In such a circumstance, the facility manager may centrally manage the facility care and maintenance, and may utilize the systems and methods of the present invention to obtain inspections and repair vendors as necessary.

Alternatively, a facility manager may be a contractor that may provide service to one or, more likely, a plurality of companies, each of which may have one or more facilities to manage. In such a circumstance, the contractor may utilize the systems and methods of the present invention to provide a service to his or her clients to manage their facilities, and representatives from his or her clients may have the ability to track, in real time, the care and maintenance of their facilities, managed by the contractor. For example, the contractor may be a roofer, and the contractor may have a plurality of clients, each of which has a plurality of facilities. The roofer may utilize the systems and methods of the present invention to inspect the roofs of and/or dispatch repair to the one or more facilities managed by the contractor. Thus, the facility manager, as described herein, may be responsible for only a portion or section of the facilities, such as the roofs, for example.

Pursuant to the description provided herein, exemplary facility managers are generally described as managers within a company having their own facilities managed. However, and according to the above, it should be apparent that the facility manager may be outside the company, preferably the vendor him or herself, that may provide the utilization of the modules described herein. In other words, as described below, the inspector, the control manager and the vendor may be three different parties, or the same party.

### System Overview

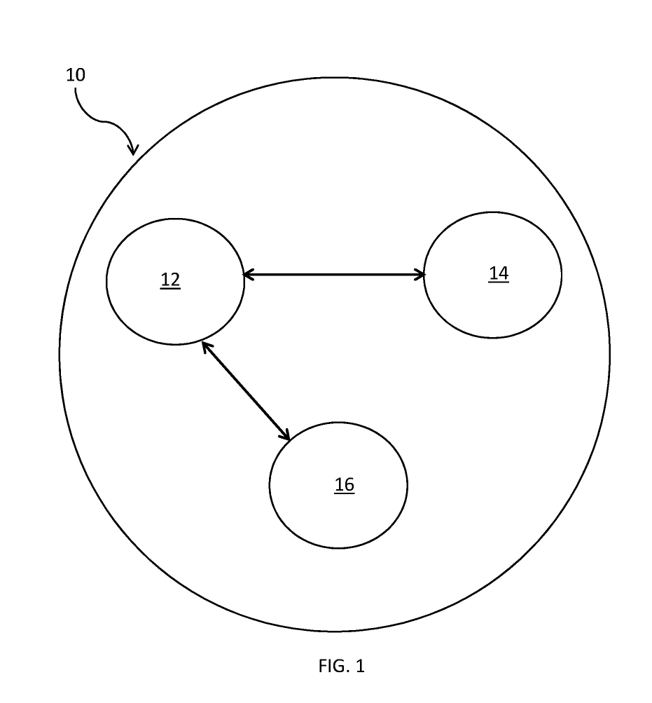

Referring now to the figures, FIG. 1 illustrates an overview of the systems and methods of the present invention. Specifically, FIG. 1 illustrates a system 10 that comprises a plurality of modules 12, 14, 16 that interconnect to provide a facility control manager the ability to review information concerning one or more facilities that may be managed by a company or other organization. Specifically, the present invention comprises one or more “Control Application Modules” 12 that houses information relating to the one or more facilities under management control by the company or organization. Specifically, the Control Application Modules 12 may include information about the one or more facilities, contained within one or more easily accessible databases, and provided in a manner that is easy to read and understand by a facility manager. Moreover, the Control Application Modules 12 may track notes and history relating to the one or more facilities, as well as provide geographical mapping (“geo mapping”) of the one or more facilities. Ultimately, the Control Application Modules 12 allow a facility manager to manage repairs that may be required on the one or more facilities through the Control Application Modules 12, as well as the other application modules described herein. Specifically, the system 10 allows a facility manager to easily request inspections of facilities, order repairs for facilities, and track any and all necessary information relating to the inspections and/or repairs, as described in further detail below.

The system 10, as illustrated in FIG. 1, may further include “Inspection Application Modules” 14 that may allow an individual, such as a vendor or other individual having the necessary expertise, to conduct inspections of one or more facilities or aspects and components thereof. Specifically, the Inspection Application Modules 14 may contain one or more modules that allow an individual to build reports at the same time as the inspection is conducted, as well as providing facility managers with access to the reports such that the facility managers may interact with the reports as necessary. Moreover, the individuals conducting the inspections may be able to email the reports to interested parties after generation thereof, for review.

The system 10 may further include “Dispatch Application Modules”16 that may allow a facility manager and a vendor to communicate with each other to have necessary repair work conducted on the one or more facilities. Specifically, Dispatch Application Modules 16 may track all repair dispatches from the time of the generation and submission of the repair dispatch, to the resolution of the repair dispatch. Moreover, the Dispatch Application Modules 16 allow a repair vendor to punch in and out, allowing reports to be generated on time spent on a repair, as well as allows reports to be generated by the vendor at the same time as a repair is completed, or soon thereafter. In addition, the Dispatch Application Modules 16 allow a repair vendor to suggest and document additional repair items that may be seen at the time of performing the repair noted in the repair dispatch, thus providing more efficient workflow for the vendor.

The application modules 12, 14, 16 described herein may be accessed by and viewed on any computing device known to those of ordinary skill in the art. For example, the modules 12, 14, 16 may be accessible by personal computers, laptop computers, tablet personal computers, personal digital assistants, mobile telephones, and other like devices. Preferably, the Control Application Modules 12 may be accessible using a personal computing device or a tablet PC, while the Inspection Application Modules 14 and/or the Dispatch Application Modules 16 may be accessible via a table PC or mobile telephone device, such as an iPhone or other like device.

The Control Application Modules 12 may allow one or more facility managers access to a plurality of facilities that they may be tasked with managing. Thus, a facility manager may access the Control Application Modules 12 and may be presented with a list of one or more facilities managed. A head shot photograph or other indicator may be shown demonstrating that the manager is tasked with managing the one or more facilities on the list provided. The facilities may be listed in a predetermined order such that a user may have easy accessibility to the list of facilities, and may be able to select each individually by scrolling and/or clicking thereon using a cursor, touchpad, touch-sensitive screen, mouse or other input device. The list of facilities may have basic information shown about each facility, such as location, square footage, grade, and division, for example. The information about each of the facilities may offer a quick overview of where the facility may be located, the size of the facilities, and a rating grade based on any inspections that may have been performed on each of the facilities, as will be described in more detail below.

Moreover, other information may be accessible from the Control Application Modules 12. For example, information concerning Comments about the facilities may be provided, as well as Service Dispatches that may have been issued and/or resolved, Bid Procurement information, and cost information contained within a Budget Matrix for each of the facilities. Thus, a facilities manager may have necessary information concerning the facilities easily accessible and useful for allowing a facilities manager to properly manage the facilities under his or her purview.

Geo mapping may be performed of one or more of a plurality of facilities around a common geographic region. Specifically, when the mapping feature may be selected by a facilities manager or other user, the facilities may be shown on a map with flags representing the locations of the particular facilities. The facilities may be selected via cursor by clicking on any of the flags shown on the geo map.

Once a facility is selected by a user of the Control Application Modules 12, a photograph of a particular facility, as well as information that may be related to the particular facility, may be displayed. The facility, as noted, may be shown in a photograph, such as a birds-eye view of the facility to give the user an understanding of the relative size and shape of the facility. Oftentimes, a facility manager may generally know the facilities under his or her purview, and the photograph of the particular facility may allow the facility manager to better understand which facility he or she has selected for review. Moreover, the facility may be divided into sections that may be individually tracked in a “Sections” area viewable by the user. The Sections area may contain information concerning the sections of the facility, such as names for the sections, area of the sections, the types of the sections, as well as individual ratings (“grades”) for each of the sections. The ratings of each of the sections may be generated by individuals that may have conducted inspections thereof.

If a section of the facility is selected, “Section Information” may be shown to the user, which may show pertinent information relating to the particular section of the facility that is selected. For example, information concerning Summary information about the section, as well as information concerning the section's Composition, Observations about the section, a Condition Summary of the section, a Recommendation for the section, as well as a Print option may be provided. A photograph of a pertinent element or feature within the section may be shown, and information concerning that particular element or feature may be displayed, such as if Observations is selected by the user. Additional photographs may be provided for the section to the user at this time, as apparent to one of ordinary skill in the art.

If one or more of the additional photograph are selected, they may be viewed in larger format to provide additional detail to a user. Other elements or features of the section of the facility may also be viewed in larger format with greater detail. Moreover, information concerning each of the features or elements may be provided with the photographs, such as below the photographs. The information may concern noticeable issues requiring maintenance thereof, for example.

A Condition Summary of the section may be displayed to the user. The Condition Summary may provide pertinent information concerning a section of the facility, and may be presented in an easy-to-read and easily accessible fashion to a facility manager. For example, a particular section viewed may be graded, showing information to the user about the projected longevity of the section, and whether repairs and/or maintenance will be required at a point in the future. Further details concerning how the grade was determined may be provided. In a preferred embodiment, the grades are provided in standard scholastic grading, such as “A” (for excellent condition) to “F” (for failing).

Recommendation information may be provided to the user in a visual format. The Recommendation information may present information to the facility manager to aid the facility manager in making decisions about repairing and/or maintaining the section of the facility. Specifically, options may be presented, such as whether Remedial maintenance is recommended, and the estimated cost thereof, or whether Replacement is recommended, and the estimated cost associated therewith.

The user may select a Print option, which may allow the user to print a report of the condition of the facility or section thereof. The report may then be sent to a printer and printed for a hardcopy file thereof.

### Inspection

In an embodiment of the present invention, an inspection of a facility may be performed, and the results of the inspection may be compiled and reported instantaneously or nearly instantaneously to interested parties. Specifically, a facility manager may have an inspection performed by a vendor, such as a contractor or other individual skilled in performing inspections of facilities to rate the condition of the facility and/or elements thereof and provide recommendations on how best to manage the facility, such as whether maintenance may be required immediately or at some point in the future. Alternatively, the vendor itself may be the facility manager, and may schedule and conduct inspections as necessary, pursuant to the present invention.

An application for an inspector of a facility may be viewable on a portable electronic device, such as a cellular telephone, a PDA, a tablet PC, a laptop PC or other mobile device. In a preferred example, the application may be run on an iPhone or iPad, and information gathered through the inspection process may be input via the iPhone. Specifically, a schedule may be accessed via the portable electronic device. Moreover, in embodiments of the present invention, systems described herein may keep a schedule whereby an inspector may be able to view when the inspection has been scheduled. Each inspection may be contained on the schedule, and the inspector may be given an option to select the project from the schedule, which may start the inspection process, as described herein.

A photograph or other graphical representation of the facility that is set for inspection may be provided to an inspector and selected by the inspector from the schedule. The photograph or graphical representation may provide the inspector the ability to confirm that the facility that is scheduled to be inspected is the same as the facility that the inspector is inspecting or is going to inspect. Once the facility is confirmed for inspection, the inspector may select a portion of the facility to begin the inspection process. It is preferred that a facility, such as a large facility, be divided into smaller portions to provide for easier inspection and reporting of issues that may be contained within the facility requiring maintenance or further work. Thus, the inspector may select a particular portion of the facility for inspection. For example, the roof of a facility may be inspected; however, any feature contained within the facility or portion thereof may be inspected pursuant to the systems and methods contained herein, such as structural elements, including walls, windows, etc. or environmental elements, such as HVAC, plumbing or other like elements, and the invention should not be limited as described herein with respect to the particular examples.

The inspector may select pre-defined portions of the facility, such as portions that have already been defined by a previous user of the systems described herein. Alternatively, the inspector may define the sections him or herself as he or she inspects the facility. If the inspector is provided the opportunity to define the portions, he or she may select the area of the portion to be inspected via cursor or touchscreen of the portable electronic device, or via any other manner. The inspector may then name the section to be inspected, and save the section for future reference.

The inspector may then perform the inspection of the facility or the section of the facility selected by the inspector for inspection. Thus, the inspector may physically inspect, review and notate any problems or issues that the inspector may see during the inspection. For example, the inspector may be provided the ability to take photographs or video of any element or feature that the inspector deems noteworthy. Preferably, the inspector may take photographs or video by turning the portable electronic device to fully capture the image.

Once the photograph or video is recorded via the portable electronic device, the photograph or video may be tagged with information that may be input relating to the photograph or video. For example, a “composition” inspection may be performed that allows the inspector to take a photograph and input information about compositional features of the facility or the portion of the facility being inspected. For example, the roof may be dissected to determine the materials present in the roof. The inspector may determine that the roof has a “metal” deck and may have “‘2’ fiber glass” as a layer. Further layers or other compositional features may be added by the inspector.

Elements of the facility or sections thereof deemed noteworthy by the inspector may be photographed after the inspector selects a “Deficiency” input screen. Specifically, a “Curb flashing failure” may be photographed, and information concerning the deficiency may be noted, along with input fields for a recommended course of action and estimated repair cost for repairing the deficiency.

A condition of the facility or section thereof may be graded by the inspector. For example, if the roof of a particular section of the facility is inspected by the inspector, certain elements of the roof may be queried for the condition thereof, such as the membrane, the flashing, the sheet metal, as well as the overall condition. The inspector may input grades for these elements of the roof. Moreover, a projected roof replacement date may be provided, as well as an optional estimated cost per square foot for replacing the roof. Of course, other features inspected may also be subdivided into particular elements for rating thereof, such as windows, walls, HVAC, plumbing, and other like features and systems.

Recommendations may be added by the inspector, which may allow the inspector to input whether any particular element, or perhaps the entirety of the facility or section thereof needs emergency repairs (if an emergency condition exists), remedial repairs (to ward off an emergency repair, for example), or whether the entirety requires replacement. Comments regarding any of the particular selection may be input by the inspector of any of the remedial repairs. Once the inspection is completed, an option may be provided to the inspector to “Add Additional Sections” to the inspection report, or to “Complete Inspection”. If “Add Additional Sections” is selected, the inspector may go through the inspection process again for a different section of the facility, as described above. Alternatively, if “Complete Inspection” is selected by the inspector, then the inspection report may be generated.

If the inspector selects “Complete Inspection”, a dispatch code may be generated, and a notation that a dispatcher of the system has been contacted for uploading the report the inspector has generated and completed. The dispatch code may allow internal tracking of the generation of reports, and information concerning the report, such as when uploaded, validated, and other like information, may be saved in a database for recall at a later time.

The inspection report, as generated by the inspector pursuant to the system and methodology described herein, may thus be loaded and generated. Moreover, a pdf draft of the inspection report may be viewed via the portable electronic device, and the inspector may verify that all relevant information is present and accurate. Once satisfied, the inspector may wait for an approval from the system dispatcher, who may review the report and determine whether it is satisfactory for submission to facility managers and other interested parties. An approval code may be generated that records and tracks necessary information concerning the approval of the report, and the report may be submitted to the interested parties via inputting of email addresses of the interested parties or other contact information. Pages of the report may then be received by the interested parties in pdf format, preferably, or in any other format necessary for review thereof. Moreover, the report may be saved within a database within the system, and associated with the facility, such that anyone having access to the facility via the system described herein may view the report at a later time.

### Remote Control by Facility Manager

A facility manager may have access to the system as described herein for review of inspections, repair requests, reports, and/or any other information necessary for managing the one or more facilities. For example, the facility manager may have access via the system utilizing any electronic computing device. Preferably, the facility manager may have access via a portable electronic device which may allow the facility manager to manage the facilities under his or her domain in any location accessible via Wi-Fi, cellular telephone networks or other like networks. A login security may be provided requiring a manager to present security credentials to gain access. Upon access, a home page may be provided to the manager providing a list of facilities for viewing in the system, location information, and any other information that may be useful for a facility manager. Once selected, further information about a particular facility (“Property”) may be shown to the facility manager or other user thereof.

### Repair Dispatch

During inspection or simply during typical use of a facility, a particular element of the facility or section thereof may be found to require maintenance. In a non-limiting example, a leak may be identified by an inspector of the facility in the NW corner of a section of the facility. Further information may be provided by the inspector, such as the nature of the leak, the seriousness of the leak, estimated pricing information, and any other information useful to the manager to make a decision about the facility. If the manager deems the repair to be necessary, the manager may click “SEND DISPATCH” on his or her portable electronic device, which may send a service dispatch to a vendor for repairing the same. The vendor may be preselected, such that sending the dispatch automatically sends the service dispatch to a desired vendor. Alternatively, a list of vendors able to handle the repair may be presented to the manager, and he or she may be presented an option to select the particular vendor to send the service dispatch. Once sent, the manager may return to his or her Home screen and select other options to manage the facility. Moreover, if the facility manager and the vendor are the same, then the vendor may contact the company to communicate the repair needed. All information relating to a particular company may be accessible by the company on a secure website so that the company may be kept apprised of all repair work needed and performed. Once the vendor has permission, the vendor may send a repair agent to the facility for repair thereof, pursuant to the present invention.

A summary of the dispatch may be created and recorded by the systems and methods of the present invention, and may be sent to the vendor, relating pertinent information thereof, such as the service dispatch number, the business or other organization, the facility at issue, the section of the facility at issue, a corporate contact for the service dispatch, a site contact at the facility, and information concerning who sent the dispatch, as well as a date and time stamp. At the same time, a service ticket may be generate, which may build throughout the cycle of the service ticket. For example, the service ticket may have information thereon that mirrors the information viewable on the portable electronic device. In addition, further information may be provided, such as whether the repair work needed is an emergency, including notes on the issue needing repair. A status bar may be shown at the bottom of the electronic service ticket showing what stage the service ticket is at, reflecting the status of the repair work to be performed. Thus, one may view and track, instantaneously or in real time, or nearly instantaneously, the status of the repair work as it is being performed at the facility by the vendor, as described in more detail below.

The vendor may utilize an application housed on his or her portable electronic device that may be interconnected to the system and methods of the present invention (such as, for example, via logon access over the Internet or the like) to provide the vendor with access to the information contained within the system, and to receive dispatch notifications as well as other communications sent by users of the system of the present invention. Specifically, a vendor may login to the system and may be provided a screen where the vendor may view a schedule of upcoming service calls to the facility, a calendar showing the same, a search option allowing searching of information accessible, a company contacts options allowing information to be obtained about individuals to contact at the corporation and/or at facilities thereof, and a service dispatch option, providing viewable information about service dispatches sent to the vendor. The vendor may utilize these options to schedule the service call to the facility based on the dispatch sent to the vendor, as described above. For example, the vendor may schedule the service call directly through the portable electronic device, and the service ticket may be automatically updated, reflecting the information concerning the scheduling of the service call.

A “punch-in” screen may be provided on the vendor's portable electronic device for the electronic service ticket that may be generated when the vendor starts the needed repairs. The “punch-in” screen on the vendor's portable electronic device may allow the vendor to input information relating to the date and time of arrival on the site and/or when the vendor may begin work on the repairs. Options may be presented to the vendor relating to punching in and beginning the work.

A graphical representation of the facility being serviced by the vendor and a map showing the various sections of the facility may be presented to the vendor on his or her portable electronic device. Thus, the vendor may gain important information about the facility to aid the vendor in determining the layout of the facility. The information provided to the vendor by the dispatch may allow a vendor to hone in on where the possible issue may be in the facility. A vendor may then conduct an inspection of the facility and/or pertinent section thereof to determine the causes and/or likely causes of the issue needing repair. The electronic service ticket may be updated to show that the vendor is conducting the repair and that the repair is “in progress.”

During the inspection of the facility and/or the sections of the facility to determine the cause and/or likely causes of the issued needed repair, the vendor may be provided an option to document noted problems by selected an “Add Photo/Video” option on his or her portable electronic device. The progress of the repair may continue to be shown and reflected on the service ticket, indicating that the service is “in progress.”

As noted above, options may be provided to a vendor for adding photographs and/or videos to the service ticket. Thus, a photograph may be taken and information may be input and associated with the photograph on the vendor's portable electronic device. The photograph and the description of the issue found by the vendor needing repair may be uploaded or otherwise added to the electronic service ticket showing that the problem discovered by the vendor has been updated thereon. The vendor may select whether to add to or change the photograph, or select “next”, which may input the photograph to the service ticket. Further options may be presented to the vendor, such as adding a “correction” report for the issue needing repair, discovered, and documented, as noted above.

When correcting the issue or the problem associated with the section of the facility, the vendor may select “Add correction”, which may allow the vendor to input a photograph of the repair work completed, as well as a description of the repair work completed. Once satisfied, the vendor may save the information, which may become associated with the photograph. The information may then be added to the service ticket. Once completed, the photograph, which shows and describes the work completed, may be saved to the electronic service ticket. An additional problem may be identified and require corrective action relating to the service dispatch and problem to be solved. Once identified, corrective action may be performed, and documented, as described above. Of course, the electronic service ticket may continually update in real time, or nearly instantaneously, to provide an accessible report of the work being conducted by the vendor as he or she is performing and documenting the same.

Once completed, the systems and methods of the present invention may walk the vendor through confirmation screens to close the service ticket and indicate that the repairs have been completed. For example, the vendor may be queried whether the facility shown in the graphic is the same as the one the vendor serviced, which may provide confirmatory information that the vendor performed work on the correct facility. The vendor may further be queried to indicate where on the facility work was performed by tapping his or her finder on the touch-sensitive screen. Of course, any other manner of providing the information may be performed, such as via cursor, stylus or any other manner. Thus, the vendor may provide detailed information concerning the locations of any issues requiring repair. Finally, the vendor may be queried whether the vendor is finished with the repair or whether additional repair items should be added. For example, the vendor may see an issue unrelated to the service dispatch requiring repair. Thus, the vendor may select an option “Add repair item” to document the additional repair that may be necessary. This may be useful if there is another issue requiring action, whether an emergency or requiring remedial action.

The systems and methods of the present invention may allow a vendor to input information relating to additional repair items, including photographs that may be added and pertinent information concerning the additional repair needed, such as whether the repair may be classified as “emergency” or “remedial”, the “quantity” of the element needing repair, such as a length or other measurement, a description of the issue, a corrective action recommended, and a repair cost estimated. This may then be added to the service ticket, and may be viewable by a facility manager, who then may be able to immediately or nearly immediately act on the information and provide instructions to the vendor for repairing the item.

One or both of a facility manager and/or a vendor may view, via the facility manager's portable electronic device and/or the vendor's portable electronic device, the repair work performed on the facility. Colored dots on a graphical representation of the facility may show where work has been performed. Upon hitting “next”, the facility manager and/or vendor may view a photograph and description of an issue discovered by the vendor and documented, as described above. The facility manager may view the description of the work needed, performed, and further repairs discovered, and may digitally sign that he or she has reviewed the information contained therein. Specifically, the facility manager may place his or her electronic signature in a signature field, using the touch-sensitive screen, using a cursor, a stylus, or any other method. Thus, the facility manager and vendor may simultaneously view the repair work at the time of completion by the vendor, and provide acknowledgement that the repair work has been completed, and provide authorization for additional repair work. This may be particularly useful if the vendor and facility manager are able to view together and discuss over a telephone connection. If additional repair work is approved, the vendor may receive the authorization on his or her portable electronic device, and the vendor may proceed with the additional repairs, documenting the same as described above.

A “punch-out” screen may be provided to the vendor who may input the time of completion of the repair work, and may input the materials utilized to perform the repair work. Thus, an invoice may be automatically generated, including the time taken for completion as well as the materials utilized in the repair. Once completed, the electronic service ticket may be updated as “Confirmed”, and the vendor may be presented with an option to view a pdf copy of the service report indicating all work performed and documented by the vendor, as well as the acknowledgement and authorization of the facility manager, and further including an invoice for the service performed by the vendor.

The completed electronic service ticket may be viewable by the vendor, such as in a pdf format, showing all work performed and other pertinent information relating to the repair. The report may then be reviewed by a system dispatcher for verification that the report is generated and presented correctly. An approval code may be provided by the dispatcher, which may be attached to the report, thereby allowing the report to be submitted to interested parties, such as via email or other communication method. The completed report may be viewable by an interested party, such as a party that may receive the report from the vendor directly. Alternatively, a facility manager may send the pdf copy of the report to interested parties, such as by sending from the system database storing the report. The information contained in the report may be accessible to a user of the system, which shows a page that may be accessible by a facility manager, for example, via the system of the present invention. The report may be accessible by an electronic computing device, such as a PC, a tablet PC, such as an iPad, a cellular telephone, or other like electronic device.

Pertinent historical information about the repair to the facility may be accessed and viewable by a facility manager at any time. For example, the screenshot 610 shows information concerning the repair dispatch may be shown to a facility manager, such as a unique identifier for the dispatch, the priority of the dispatch (such as “emergency” or “remedial”), the date and time dispatched, the arrival ETA, when “in progress”, when “received” by the vendor, when repairs “confirmed” by the facility manager, and when invoiced. Any other pertinent information may be provided to a facility manager as apparent to one of ordinary skill in the art.

### Other Options

Additional functionality may be provided by the systems and methods of the present invention. For example, a facility manager may utilize the systems to request bids from vendors for work to be performed. Thus, once work is identified, such as through a repair request, maintenance request, remediation request or other like request, or through a capital project request (such as for an addition to a building or other upgrade), a bid proposal may be requested by the facility manager. The bid proposal request may include pertinent information relating to the work to be performed, including photographs, inputted information, graphics, drawings, or other like information. The bid proposal requests may be sent to a plurality of vendors for review, whereupon the vendors may input their bid proposals and submit back through the system of the present invention. Thus, a facility manager may receive the bid proposals through the systems, and the bid proposals may automatically be contained within a central and easily accessible location for review and comparison thereof. The facility manager may make decisions on accepting or denying particular bids and may communicate the approvals or denials directly to the vendors via the system. The work performed by the approved vendor on the needed repair or capital project may then be scheduled, performed, completed and reported, as described above.

In addition, vendors that may perform work on one or more facilities, pursuant to the systems and methodology described herein, and may be graded by facility managers, and the grades may be stored within the databases of the systems provided herein for accessibility at later times. Thus, a facility manager may be able to determine whether to call a particular vendor, based on the grade stored in the system. For example, the vendor may be graded on time to completion, thoroughness of the repair work, cleanliness of the repair work, cost for providing service, or any other criteria that may be useful to determine whether to utilize the vendor in the future.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A method for centrally managing a facility comprising:
providing a facility requiring maintenance;
providing a database comprising a report relating to maintenance requirements of the facility;
retrieving the report on a first electronic computing device from the database via a control application module interconnected with the database;
creating an electronic service ticket relating to the maintenance requirements of the facility;
sending a request for service to a vendor from the first computing device; and
providing access to the electronic service ticket to the vendor, wherein the vendor adds information to the service ticket to create an updated electronic service ticket using a second electronic computing device.

2. The method of claim 1 wherein the report relating to the maintenance requirements of the facility is generated by the steps of:
providing access to the facility to an inspector, wherein the inspector creates the report on a third electronic computing device relating to the maintenance requirements of the facility and wherein the inspector saves the report to the database.

3. The method of claim 2 further comprising:
providing an inspection application module on the electronic computing device of the inspector, wherein the inspection application module is interconnected to the control application module.

4. The method of claim 2 wherein the inspector inspects a portion of the facility, and further wherein the report relates to maintenance requirements of the portion of the facility.

5. The method of claim 2 wherein the inspector adds photographs to the report.

6. The method of claim 5 wherein the inspector tags the photographs with information.

7. The method of claim 2 wherein the third electronic computing device is a portable electronic computing device.

8. The method of claim 1 further comprising the steps of:
providing a graphic interface on the first computing device, wherein the control application provides a map on the graphic interface on the first computing device, wherein the map shows the facility.

9. The method of claim 1 wherein the database comprises information relating to a plurality of vendors, and the vendor selected for sending the request for service is one of the plurality of vendors.

10. The method of claim 1 wherein the database comprises information relating to a plurality of facilities requiring maintenance, wherein the facility selected for service is one of the plurality of facilities.

11. The method of claim 1 further comprising:
requesting an inspection on the facility, wherein the request for the inspection is generated by the control application module and sent to the inspector, wherein the report relating to the maintenance requirements of the facility is generated after the request for inspection is received by the inspector.

12. The method of claim 1 wherein the vendor adds photographs to the electronic service ticket using the second electronic computing device to create the updated electronic service ticket.

13. The method of claim 11 wherein the vendor tags the photographs with information using the second electronic computing device to create the updated electronic service ticket.

14. The method of claim 1 wherein the vendor adds information to the electronic service ticket relating to a repair performed on the facility using the second electronic computing device to create the updated electronic service ticket.

15. The method of claim 1 wherein the second electronic computing device is a portable electronic computing device.

16. The method of claim 1 wherein the vendor adds information to the electronic service ticket relating to additional repair needs required by the facility to create the updated electronic service ticket.

17. The method of claim 1 further comprising the step of:
sending a map showing the facility from the control application module to the second electronic computing device for use by the vendor.

18. The method of claim 1 wherein the information added to the electronic service ticket relates to cost information associated with repairing the facility.

19. The method of claim 1 wherein the vendor saves the updated electronic service ticket to the database using the second electronic computing device.

20. The method of claim 1 wherein the electronic service ticket comprises a request for bids from a plurality of vendors, and further comprising the steps of:
submitting the electronic service ticket to the plurality of vendors; and
retrieving a plurality of updated electronic service tickets from the plurality of vendors, wherein each updated electronic service ticket comprises bid information.
